SEQUENCE LISTING (3 sequences)

SEQ ID NO: 1 - DNA, 45 bp, Artificial sequence
  Synthesized target nucleic acid strand
gaagcaggcccctgcaatcctctcctgggcagtcgttcggatatc

SEQ ID NO: 2 - DNA, 21 bp, Artificial sequence
  Synthesized capture strand
aggattgcaggggcctgcttc

SEQ ID NO: 3 - DNA, 22 bp, Artificial sequence
  Synthesized detection strand
gatatccgaacgactgcccagg

(19) United States
(12) Patent Application Publication
(10) Pub. No.: US 2012/0010097 A1
(43) Pub. Date: Jan. 12, 2012

(54) MICROCHANNEL, AND NUCLEIC ACID HYBRIDIZATION MICROCHIP, COLUMN, SYSTEM AND METHOD

(75) Inventors: Michihiro Ohnishi, Kanagawa (JP); Naoyuki Sasaki, Tokyo (JP); Takuya Kishimoto, Tokyo (JP); Hidetoshi Watanabe, Chiba (JP)

(73) Assignee: SONY CORPORATION, Tokyo (JP)

(21) Appl. No.: 13/171,851

(22) Filed: Jun. 29, 2011

(30) Foreign Application Priority Data
Jul. 7, 2010 (JP) 2010-154678

(51) Int. Cl. C40B 30/04; C40B 40/06; B01D 35/00

(52) U.S. Cl. 506/9; 422/534; 506/16

(57) ABSTRACT

A microchannel capable of passing therethrough a solution with target nucleic acid strands contained therein includes: an agarose gel carrier having light transmission properties, supporting capture strands having a base sequence complementary to that of the target nucleic acid strands and immobilized on the agarose gel carrier, and packed in the microchannel; and a filter arranged in the microchannel on a downstream side as viewed in a passing direction of the solution and retaining the agarose gel carrier.

### CROSS REFERENCES TO RELATED APPLICATIONS

The present application claims priority to Japanese Priority Patent Application JP 2010-154678 filed in the Japan Patent Office on Jul. 7, 2010, the entire content of which is hereby incorporated by reference.

### BACKGROUND

The present application relates to a microchannel and also to a nucleic acid hybridization microchip, column, system and method. More specifically, the disclosure relates to a microchannel with an agarose gel carrier having light transmission properties and packed as a nucleic acid separation carrier and also to a like microchip, column, system and method.

In recent years, advances have been made in the development of bioassay technologies usable in the analyses of mutations, polymorphisms, expression levels, networks and the like of genes, including, for example, methods making use of integrated substrates called “DNA chips” or “DNA microarrays.” Sensor chip technologies represented by DNA chips or protein chips with proteins integrated thereon isolate and detect target substances in samples by using specific interactions between the target substances and their corresponding detection substances.

Recently, a application has been proposed to perform an interaction between a target substance and a detection substance in a channel or capillary. As applications of an interaction between substances, there have also been proposed technologies that allow a hybridization reaction to proceed between nucleic acids in a channel or capillary. For example, Japanese Patent Laid-Open No. 2005-130795 discloses an analysis member for a polynucleotide, in which a section, where amplification of the polynucleotide is to be performed, and a hybridization section, which has a porous layer with a detection oligonucleotide immobilized thereon, is connected to each other via a channel. Japanese Patent Laid-Open No. 2004-121226 discloses an analysis method of a polynucleotide, which immobilizes a probe compound on the inner wall of a capillary channel and allows hybridization to proceed with the test polynucleotide.

Upon allowing an interaction to proceed between substances in a channel or capillary, a problem arises in that the internal pressure of the channel or capillary significantly increases as a sample solution or the like is passed. Especially when a target substance is nucleic acid strands, hybridization of the nucleic acid strands proceeds in the narrow channel or capillary so that the actual volume of the channel or capillary may decrease and the internal pressure of the channel or capillary may rise. When nucleic acid strands other than the target nucleic acid strands are non-specifically adsorbed in the channel or capillary, clogging of the channel or capillary takes place and the internal pressure of the channel or capillary rises.

The present inventors provided in Japanese Patent Laid-Open No. 2009-268385 (hereinafter referred to as Patent Document 1) a microchannel system that can avoid clogging of a channel or capillary (which may hereinafter be called a “microchannel”) and can hence prevent a rise in internal pressure. This microchannel system is packed with a nucleic acid separation carrier, which includes a porous carrier and capture strands having a base sequence complementary to target nucleic acid strands and immobilized on the porous carrier (see, Patent Document 1, claim 6).

### SUMMARY

According to the microchannel system disclosed in Patent Document 1, the use of the porous carrier (for example, perfusion chromatography particles) as the nucleic acid separation carrier has made it possible to prevent a rise in the internal pressure of a channel and hence to perform the passing of a solution at a high flow rate.

Upon optically detecting target nucleic acid strands while relying upon a fluorescent substance, excitation light is irradiated onto the fluorescent substance and fluorescence is emitted from the fluorescent substance. These excitation light and fluorescence are, however, blocked, reflected or scattered by the porous carrier if the carrier is not provided with light transmission properties. When the excitation light and fluorescence are blocked by the carrier, no sufficient detection intensity of fluorescence can be obtained, leading to a decrease in the detection accuracy of the target nucleic acid strands. When excitation light and fluorescence are reflected or scattered by the carrier, on the other hand, the background noise becomes higher and the dynamic range becomes smaller at the time of the detection of fluorescence, and therefore, the detection accuracy of the target nucleic acid strands is lowered.

It is, therefore, desired to provide a application that in a microchannel packed with a nucleic acid separation carrier, can prevent blocking, reflection or scattering of excitation light and fluorescence, which occurs by the carrier having no optical transmission properties, and can perform optical detection of target nucleic acid strands with high accuracy.

According to an embodiment, there is provided a microchannel capable of passing therethrough a solution with target nucleic acid strands contained therein, including:

an agarose gel carrier having light transmission properties, supporting capture strands having a base sequence complementary to that of the target nucleic acid strands and immobilized on the agarose gel carrier, and packed in the microchannel, and

a filter arranged in the microchannel on a downstream side as viewed in a passing direction of the solution and retaining the agarose gel carrier.

With the microchannel, the blocking, reflection or scattering of excitation light and fluorescence can be inhibited because the agarose gel carrier having light transmission properties is packed as a nucleic acid separation carrier. Further, the target nucleic acid strands can be brought in an unfragmented state into contact with the capture strands as the filter for retaining the agarose gel carrier is arranged only on the downstream side as viewed in the passing direction of the solution.

According to other embodiments, there are also provided a nucleic acid hybridization microchip and column, each including:

the above-described microchannel formed in the microchip or column,

an inlet for introducing the solution into the microchannel, and

an outlet for discharging the solution from the microchannel.

According to a further embodiment, there is also provided a nucleic acid hybridization system including:

the above-described microchip, and

at least one of a heating unit for heating the solution to be introduced through the inlet and a temperature control unit for controlling a temperature in the microchannel.

According to a still further embodiment, there is also provided a nucleic acid hybridization method including:

passing a solution, which contains target nucleic acid strands, along with an agarose-added liquid phase through a microchannel in which an agarose gel carrier, which has light transmission properties, supports capture strands having a base sequence complementary to that of the target nucleic acid strands and immobilized on the agarose gel carrier, and is packed in a state that the agarose gel carrier is retained by a filter arranged in the microchannel on a downstream side of the agarose gel carrier as viewed in a passing direction of the solution.

The nucleic acid hybridization method can inhibit the blocking, reflection or scattering of excitation light and fluorescence because the agarose gel carrier having light transmission properties is used as a nucleic acid separation carrier. Further, the target nucleic acid strands can be brought in an unfragmented state into contact with the capture strands as the filter for retaining the agarose gel carrier is arranged only on the downstream side as viewed in the passing direction of the solution. Furthermore, the use of the agarose-added liquid phase can gently stick the agarose gel carrier itself together to stabilize the same.

The microchannel according to the embodiment can prevent the blocking, reflection or scattering of excitation light and fluorescence, which occurs by the carrier having no optical transmission properties, and can perform optical detection of target nucleic acid strands with high accuracy.

Additional features and advantages are described herein, and will be apparent from the following Detailed Description and the figures.

### BRIEF DESCRIPTION OF THE FIGURES

FIGS. 1A and 1B are schematic views illustrating the construction of a nucleic acid hybridization microchip according to a second embodiment with a microchannel according to a first embodiment formed thereon, in which FIG. 1A is a top plan view and FIG. 1B is a cross-sectional view taken in the direction of arrows P-P of FIG. 1A;

FIG. 2 is a schematic view illustrating a state of immobilization of a substance on a surface of one of agarose gel beads as an agarose gel carrier;

FIG. 3 is a flow chart illustrating the procedure of a nucleic acid hybridization method according to a fourth embodiment;

FIGS. 4A to 4C are schematic views illustrating states of binding of substances on a surface of an agarose gel bead in respective steps of the nucleic acid hybridization method according to the fourth embodiment;

FIG. 5 is a schematic view illustrating the construction of a nucleic acid hybridization system according to a third embodiment;

FIG. 6 is a spectrogram illustrating the results of measurement of transmission spectra of visible light through agarose gel microbeads and polystyrene microbeads aggregated as layers on glass substrates (Test 1);

FIG. 7 is a spectrogram illustrating the results of measurement of transmission spectra of visible light through agarose gel microbeads and polystyrene microbeads packed in channels formed on acrylic microchips (Test 1);

FIG. 8 is a chromatogram illustrating the results of measurement of the base length distribution of RNA strands in a nucleic acid solution before and after passing the solution through a filter; and

FIG. 9 is a spectrogram illustrating the results of fluorescence measurement in respective steps of nucleic acid hybridization (Test 3).

### DETAILED DESCRIPTION

Embodiments of the present application will be described below in detail with reference to the drawings.

1. Microchannel, and nucleic acid hybridization microchip

(1) Nucleic acid hybridization microchip

(2) Agarose gel carrier

2. Nucleic acid hybridization method

(1) Conditioning

(2) Passing of target nucleic acid strands, followed by washing

(3) Passing of detection strands, followed by washing

(4) Detection

3. Nucleic acid hybridization system

1. Microchannel, and nucleic acid hybridization microchip

(1) Nucleic Acid Hybridization Microchip

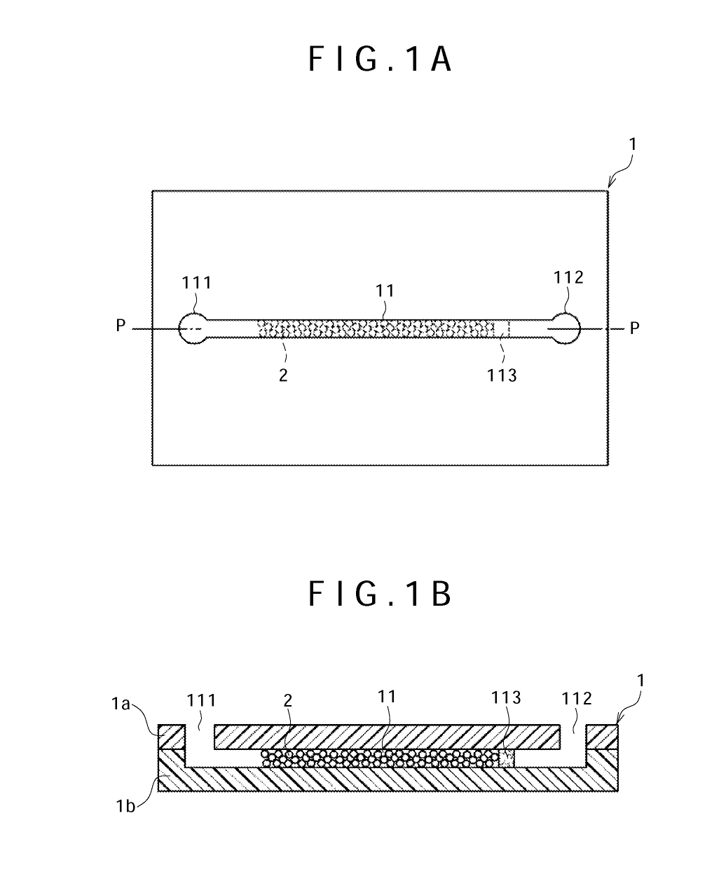

Referring to FIGS. 1A and 1B, a description will be made of the construction of the nucleic acid hybridization microchip according to the second embodiment with the microchannel according to the first embodiment formed thereon.

In FIGS. 1A and 1B, the microchannel designated at numeral 11, through which a solution containing target nucleic acid strands (hereinafter called “the sample solution”) is to be passed, is formed in the nucleic acid hybridization microchip (hereinafter called “the microchip”) indicated at numeral 1. Designated at numeral 111 is an inlet for the sample solution into the microchannel 11. Identified at numeral 112 is an outlet for the sample solution from the microchannel 11. The sample solution introduced through the inlet 111 flows through the microchannel 11, and is discharged through the outlet 112.

Packed in the microchannel 11 is an agarose gel carrier 2 as a nucleic acid separation carrier for separating the target nucleic acid strands. A filter 113 is arranged on a downstream side of the agarose gel carrier (agarose gel beads) 2 as viewed in a passing direction of the sample solution. The filter 113 is provided with pores formed therein, and these pores are formed with a pore size such that the sample solution and the target nucleic acid strands and substances such as a salt and surfactant in the sample solution are allowed to pass but the agarose gel carrier 2 is not allowed to pass. The filter 113, therefore, retains the agarose gel carrier 2 packed in the microchannel 11, and prevents the agarose gel carrier 2 from being discharged together with the sample solution, which flows through the microchannel 11, through the outlet 112. The pore size of the filter 113 can be determined as desired depending on the size of the agarose gel carrier 2, but may be set, for example, at 0.5 to 20 μm or so, with 10 μm or so being more preferred.

The filter 113 is arranged only on the downstream side of the agarose gel carrier 2 packed in the microchannel 11 as viewed in the direction of the passing direction of the sample solution, and is not arranged on an upstream side of the agarose gel carrier 2. If another filter is arranged on the upstream side, it would be possible to retain the agarose gel carrier 2 more stably in the microchannel 11. However, a potential problem would arise in that the target nucleic acid strands contained in the sample solution may be cut into fragments upon passage through the filter (see Test 2 to be described subsequently herein). Fragmentation of the target nucleic acid strands before their contact with the agarose gel carrier 2 leads to a reduction in the efficiency of a hybridization reaction with capture strands immobilized on the agarose gel carrier 2.

The microchip 1 has been constructed by bonding together a substrate layer 1b, on which the microchannel 11 is formed, with another substrate layer 1a, through which the inlet 111 and outlet 112 are formed. As the material of the substrate layers 1a and 1b, a material having light transmission properties is chosen for the optical detection of the target nucleic acid strands. For example, glass and various plastics (PP, PC, COP, PDMS) may be used. As the material of the substrate layers 1a and 1b, it is desired to choose a material having a smaller optical error for its low autofluorescence and small wavelength-dependent dispersion.

The formation of the microchannel 11 on the substrates 1b and the formation of the inlet 111 and outlet 112 through the substrate 1a can be conducted by wet etching or dry etching of glass-made substrate layers or nanoimprinting or injection molding and cutting work of plastic-made substrate layers. By bonding together the substrate layers 1a and 1b with the microchannel 11 and the inlet 111 and outlet 112 formed thereon and therethrough, the microchip 1 can be formed. The bonding of the substrate layers can be conducted by a known method such as fusion bonding, an adhesive, anodic bonding, bonding making use of a self-adhesive sheet, plasma-activated bonding, ultrasonic bonding, or the like. It is to be noted that the description is herein made by taking as an example a case that the microchip 1 is provided with one microchannel 11 but the microchip 1 may be provided with two or more microchannels 11.

(2) Agarose Gel Carrier

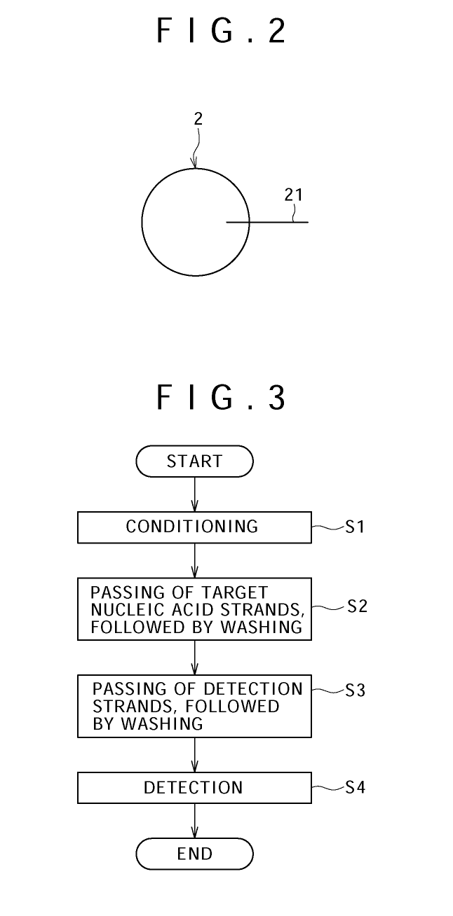

With reference to FIG. 2, a description will be made of the state of immobilization of a substance on a surface of one of agarose gel beads 2 as an agarose gel carrier.

On the surface of the agarose gel carrier (hereinafter called “the agarose gel bead”) 2, a capture strand 21 is immobilized to capture a target nucleic acid strand on the bead. It is to be noted that plural capture strands 21 are actually immobilized on each agarose gel bead but only one of the plural capture strands 21 is illustrated in FIG. 2 for the simplification of the description (this will also apply to the subsequent description). The capture strand 21 has a base sequence complementary to that of the target nucleic acid strand, and can interact with the target nucleic acid strand to form a double strand (hybrid). In the present application, such target nucleic acid strands may be, in addition to DNA and RNA strands, stands of nucleic acid analogs (for example, LNA (Locked Nucleic Acid)) obtained by modifying the structures of such nucleic acid strands at their ribose moieties. As the capture strands 21, it is possible to use those chosen from DNA strands, RNA strands, nucleic acid analog strands and the like as desired depending on the kind of the target nucleic acid strands.

No particular limitation is imposed on the length (base number) of the base sequence of each capture strand 21 insofar as it has a base sequence complementary to at least a portion of the base sequence of the target nucleic acid strand and can hence interact with the target nucleic acid strand to form a double strand. The base number of the capture strand 21 may range generally from several bases to several hundred bases, preferably from 10 bases to 100 bases or so, more preferably from 15 to 30 bases or so. Further, the capture strand 21 does not need to have a base sequence completely complementary to the base sequence of the target nucleic acid strand, and may include one or more mismatch bases (non-complementary bases) in its base sequence insofar as it can form a double strand with the target nucleic acid strand. The base sequence of the capture strand 21 may preferably be designed such that the dissociation temperature (Tm) from the target nucleic acid strand is of a similar level as the dissociation temperature between each detection strand, which will be described subsequently herein, and the target nucleic acid strand.

The immobilization of the capture strand 21 on the surface of the agarose gel bead 2 can be conducted by a known method, for example, by avidin-biotin binding or through a coupling reaction (diazo coupling reaction or the like). To use avidin-biotin binding, streptavidin is immobilized on the surface of the agarose gel bead 2, and the capture strand 21 modified at an end thereof with biotin is immobilized by the binding between avidin and biotin. As a further alternative, the immobilization of the capture strand 21 may adopt the ion-exchange binding method disclosed by the present inventors in Patent Document 1.

The above description was made taking, as an example, the case that the microchannel according to the first embodiment is practiced as a nucleic acid hybridization microchip. The microchannel according to the first embodiment can also be practiced as such a nucleic acid hybridization column as disclosed in Patent Document 1.

2. Nucleic Acid Hybridization Method

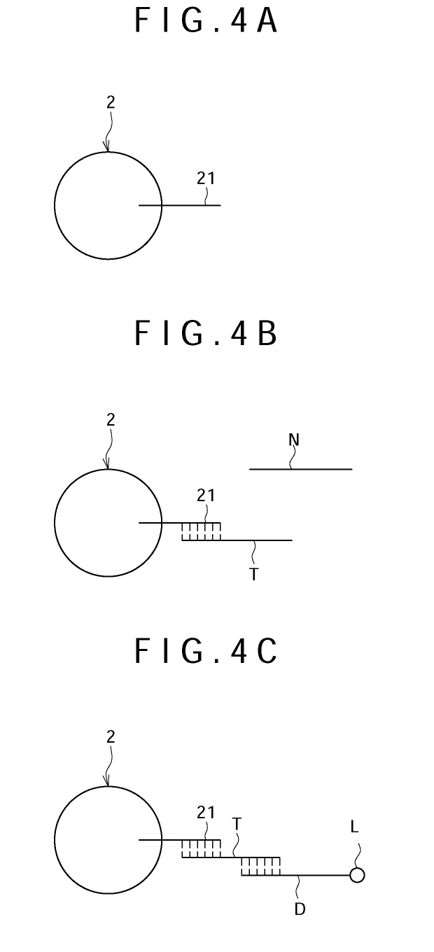

Referring next to the flow chart of FIG. 3, the procedure of the nucleic acid hybridization method according to the fourth embodiment will be described. Also referring to FIGS. 4A to 4C, a description will be of the states of binding of substances on the surface of the agarose gel bead 2 in respective steps of the nucleic acid hybridization method according to the fourth embodiment.

(1) Conditioning

In FIG. 3, step S1, a hybridization reaction buffer is introduced through the inlet 111 and is then allowed to flow through the microchannel 11 to perform conditioning of the agarose gel beads 2. This conditioning is performed to replace the liquid in the microchannel 11 and also to deaerate the microchannel 11. The state of immobilization of the capture strand 21 on the surface of each agarose bead 2 in step S1 is shown in FIG. 4A.

(2) Passing of Target Nucleic Acid Strands, Followed by Washing

In FIG. 3, step S2, a sample solution is introduced through the inlet 111 and is then allowed to flow through the microchannel 11. In this step, the capture strand 21, which has the base sequence complementary to the target nucleic acid strand, forms a double strand with the target nucleic acid strand so that the target nucleic acid strand is captured on the surface of the agarose gel bead 2.

The state of binding of the substances on the surface of the agarose gel bead 2 after step S2 is illustrated in FIG. 4B. In the figure, letter T indicates the target nucleic acid strand contained in the sample solution, and letter N designates a nucleic acid strand (non-target nucleic acid strand) other than the target nucleic acid strand.

The introduction of the sample solution may be conducted preferably by using as a liquid phase the hybridization reaction buffer employed in step S1, more preferably by using as a liquid phase the buffer with agarose added therein. The use of the agarose-added liquid phase can gently stick the agarose gel beads 2 together in the microchannel 11, and therefore, can stabilize them. The content of agarose in the liquid phase may range preferably from 0.02 to 0.2% or so, with 0.05% or so being more preferred. The agarose-added liquid phase may also be used in the respective steps of the nucleic acid hybridization method according to the fourth embodiment.

The hybridization reaction of the capture strands 21 and the target nucleic acid strands is conducted under appropriate hybrid-forming conditions by adjusting the composition of the hybridization reaction buffer (for example, the concentrations of a salt and surfactant) and the temperature in the microchannel 11. For the inhibition of self-hybridization of the target nucleic acid strands, it is effective to introduce the sample solution into the microchannel 11 after heating the sample solution beforehand. For the inhibition of non-specific adsorption of the target nucleic acid strands on the capture strands 21, on the other hand, it is effective to heat the inside of the microchannel 11 upon allowing the sample solution to flow therethrough.

After allowing the sample solution to flow, a washing solution is introduced through the inlet 111, and is then allowed to flow through the microchannel 11 to conduct washing of the agarose gel beads 2. This washing is conducted under conditions that the hybrids formed between the capture strands 21 and the target nucleic acid strands are maintained, and is conducted to remove non-target nucleic acid strands and target nucleic acid strains, which have non-specifically adsorbed on the capture strands 21, from the inside of the microchannel 11.

(3) Passing of Detection Strands, Followed by Washing

In FIG. 3, step S3, detection strands which are intended to detect the target nucleic acid strands captured on the surfaces of the agarose gel beads 2 are subsequently introduced into the microchannel 11 through the inlet 111. In this step, each detection strand having a base sequence complementary to the target nucleic acid strand and the target nucleic acid strand form a double strand, so that a sandwich hybrid of the capture strand 21-target nucleic acid strand-detection strand is formed. It is to be noted that this step may be conducted at the same time as the above-described step 2.

Similar to the capture strands 21, the detection strands have a base sequence complementary to that of the target nucleic acid strands, and interact with the target nucleic acid strands to form double strands. The detection strands can also be chosen as desired from DNA strands, RNA strands, nucleic acid analog strands or the like depending on the kind of the target nucleic acid strands, and can be used. No particular limitation is imposed on the length (base number) of the base sequence of each detection strand insofar as it has a base sequence complementary to at least a portion of the base sequence of the target nucleic acid strand and can hence interact with the target nucleic acid strand to form a double strand. The detection strand is also similar to the capture strand 21 in that the detection strand does not need to have a base sequence completely complementary to the base sequence of the target nucleic acid strand and may include one or more mismatch bases (non-complementary bases) in its base sequence insofar as it can form a double strand with the target nucleic acid strand. The base sequence of the detection strand may preferably be designed such that the dissociation temperature (Tm) from the target nucleic acid strand is of a similar level as the dissociation temperature between the capture strand 21 and the target nucleic acid strand.

Each detection strand is labeled with a label L such as a fluorescent substance, chemiluminescent substance or radioactive substance. In step S4 to be described next, the detection of target nucleic acid stands is performed by sensing fluorescence, emission or radiation generated from the label L.

The states of binding of the substances on the surface of the agarose gel bead 2 after step S3 are illustrated in FIG. 4C. In the figure, letter D indicates the detection strand. When a solution of detection strands D is passed through the microchannel 11, the detection strand D further hybridizes to each target nucleic acid strand T which has formed a hybrid with the capture strand 21. Therefore, the target nucleic acid strand T forms a hybrid with the capture strand 21 and the detection strand D, whereby a sandwich hybrid (double hybrid) is formed.

The hybridization reaction of the detection strands and the target nucleic acid strands is conducted under appropriate hybrid-forming conditions by adjusting the composition of the hybridization reaction buffer (for example, the concentrations of the salt and surfactant) and the temperature in the microchannel 11. For the inhibition of non-specific adsorption of the detection strands on the target nucleic acid strands, on the other hand, it is effective to heat the inside of the microchannel 11 upon allowing the detection strand solution to flow therethrough.

After allowing the detection strand solution to flow, a washing solution is introduced through the inlet 111, and is then allowed to flow through the microchannel 11 to conduct washing of the agarose gel beads 2. This washing is conducted under conditions that the hybrids formed between the detection strands and the target nucleic acid strands are maintained, and is conducted to remove detection strands, which have non-specifically adsorbed on the target nucleic acid strands, from the inside of the microchannel 11.

(4) Detection

In FIG. 3, step S4, the target nucleic acid strands captured on the surfaces of the agarose gel beads 2 are detected by sensing fluorescence, emission or radiation generated from the label labeled on the detection strands. Described specifically, when the detection strands are labeled, for example, with a fluorescent substance, excitation light is irradiated onto the agarose gel beads 2, and fluorescence generated from the excited fluorescent substance is sensed. Measurement of the intensity of the fluorescence or the like makes it possible to quantitatively detect the target nucleic acid strands on the basis of the intensity of the fluorescence or the like.

In the present application, the agarose gel beads 2 having light transmission properties are used as a nucleic acid separation carrier. With the agarose gel beads 2, excitation light is not blocked, reflected or scattered by the beads upon irradiation of the excitation light. In the microchannel 11 with the agarose gel beads 2 packed therein, the excitation light can reach to a depth, and intense fluorescence is generated. Further, return light from the excitation light can be reduced, thereby making it possible to set wide the dynamic range of a photodetector. In addition, with the agarose gel beads 2, fluorescence generated from the fluorescent substance is not blocked, reflected or scattered by the carrier. It is, therefore, possible to avoid an attenuation in the intensity of detected fluorescence or an increase in background noise, which would otherwise occur as a result of blocking of excitation light and fluorescence by a carrier, and hence, to detect the target nucleic acid strands with high sensitivity and high accuracy.

3. Nucleic Acid Hybridization System

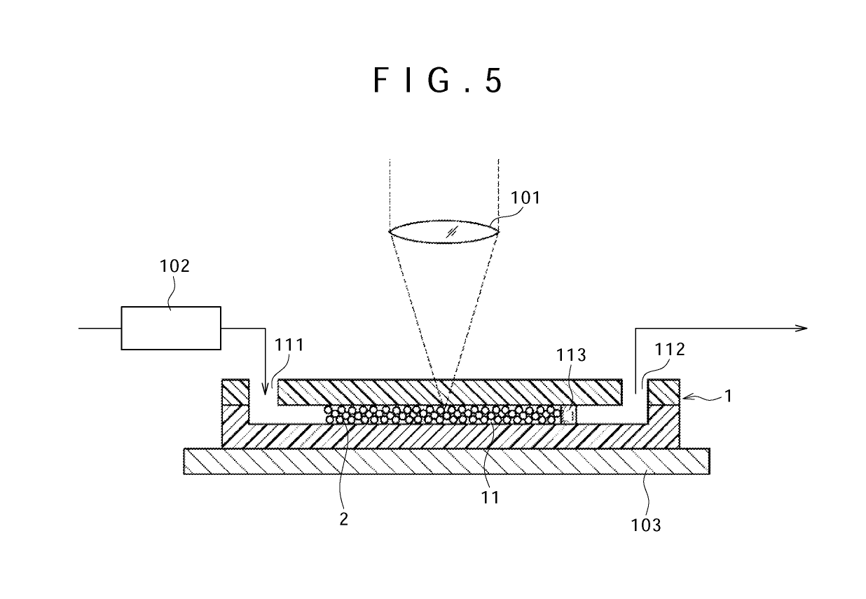

With reference to FIG. 5, the construction of a nucleic acid hybridization system according to the third embodiment will be described.

The nucleic acid hybridization system is provided with the microchip 1, a heat block 103 for controlling the temperature in the microchannel 11 of the microchip 1, feed means for feeding a solution through the inlet 111 of the microchip 1 and discharging the solution through the outlet 112 of the microchip 1, and optical detection means for irradiating excitation light onto the agarose gel beads 2 packed in the microchannel 11 of the microchip 1 and detecting generated fluorescence.

The heat block 103 functions as a temperature control unit for heating or cooling the inside of the microchannel 11 of the microchip 1. To inhibit non-specific adsorption of the target nucleic acid strands on the capture strands 21 in the above-mentioned step S2, the heat block 103 heats the inside of the microchannel 11 upon passing the sample solution. To inhibit non-specific adsorption of the detection strands on the target nucleic strands in the above-mentioned step S3, the heat block 103 also heats the inside of the microchannel 11 upon passing the detection strand solution. The heat block 103 may be a commonly-employed heater, which may be replaced to a Peltier device, Joule-Thomson device, or the like. The temperature of the heat block 103 may be set, for example, at 60° C.

The feed means can be composed of a commonly-employed pump or a syringe pump, tubes, a valve and the like. The feed means includes an in-line heater 102 as a heating unit for heating the sample solution to be introduced through the inlet 111. To inhibit the self-hybridization of the target nucleic acid strands in the above-mentioned step S2, the in-line heater 102 makes it possible to introduce the sample solution into the microchannel 11 after heating it beforehand. The self-hybridization of the target nucleic acid strands can be inhibited by quenching the sample solution while the sample solution is fed to the packed region of the agarose gel beads 2 in the microchannel 11 after its heating (thermal denaturation) in the in-line heater 102. The temperature of the in-line heater 102 may be set, for example, at 95° C.

The optical detection means can be composed an excitation light source, an irradiation system including a condenser lens, dichroic mirror, bandpass filter and the like for condensing and irradiating excitation light onto the agarose gel beads 2 packed in the microchannel 11, and a detection system for detecting fluorescence generated from the fluorescent substance, which is labeled on the detection strands, by the irradiation of the excitation light. The detection system can be composed, for example, of PMT (photomultiplier tube), an area image sensor such as a CCD or CMOS device, and so on. It is to be noted that only the condenser lens 101 is illustrated as the optical detection means in FIG. 5. It is also to be noted that the irradiation system and detection system may be arranged along different optical paths, respectively, although the irradiation system and detection system are arranged along the same optical path in FIG. 5.

Test 1

1. Evaluation of Optical Transmission Properties of Agarose Gel Microbeads

Commercially-available streptavidin-bound polystyrene microbeads (“STREPTAVIDIN COATED MICROSPHERE PLAIN,” trade name; product of Polysciences, Inc.) and commercially-available streptavidin-bound agarose gel microbeads (“STREPTAVIDIN AGAROSE RESIN,” trade name; product of Pierce Protein Research Products, Inc.) were compared in optical transmission properties. Suspensions of the respective types of beads were separately dropped onto glass-made substrates to bring them into states that they were aggregated as layers, and their visible light transmission spectra were measured.

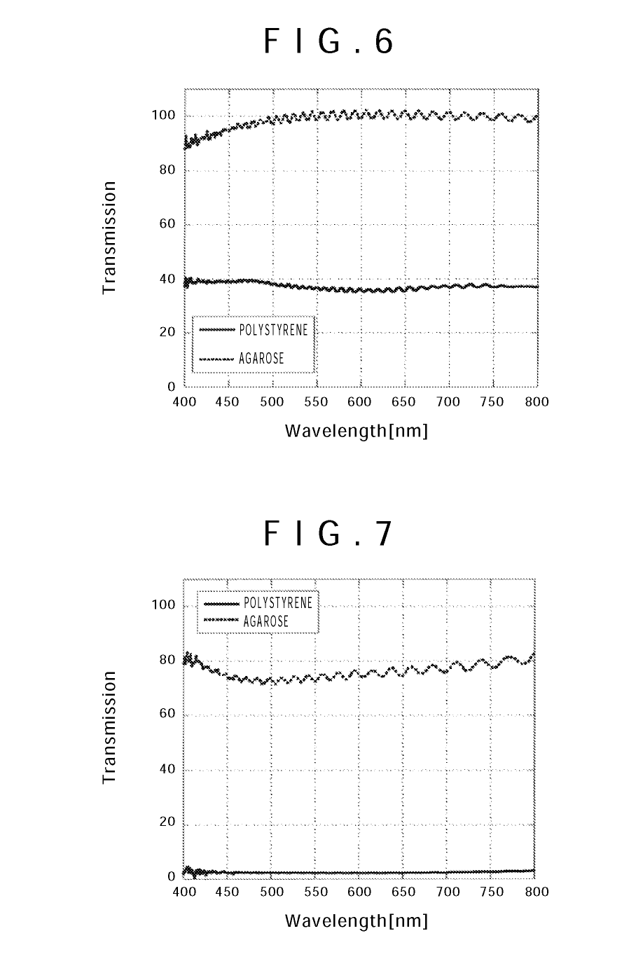

The measurement results of the transmission spectra are shown in FIG. 6. The agarose gel microbeads showed a transmission close to 100% as opposed to the approx. 40% transmission of the polystyrene microbeads.

With the respective types of beads being packed in channels (section height: 0.3 mm, section width: 0.5 mm, channel length: 2 mm) formed in acrylic microchips, visible light transmission spectra were next measured. Visible light was vertically irradiated onto each microchip to expose the beads to the visible light in the channel.

The measurement results of the transmission spectra are shown in FIG. 7. The transmission through the channel with the polystyrene microbeads packed therein was lower than 5%. In contrast, a transmission as high as 80% or so was obtained through the channel with the agarose gel microbeads packed therein.

From the results of this test, it has been indicated that agarose gel microbeads have high light transmission properties and that with a channel having them packed therein, the blocking, reflection or scattering of light can be inhibited.

Test 2

2. Evaluation of the Position of Arrangement of Filter and Fragmentation of Nucleic Acid Strands

In the channel of the acrylic microchip having the agarose gel microbeads packed therein and fabricated in Test 1, a filter of 5 μm in pore size was arranged. The channel was provided with a channel switching valve and a syringe pump.

Total RNA was extracted from HeLa cells to prepare a nucleic acid solution. Using the syringe pump, the nucleic acid solution was fed into the channel, and the nucleic acid solution which passed through the filter was recovered. Using a bioanalyzer (manufactured by Agilent Technologies, Inc.), the nucleic acid solution was subjected to electrophoresis to measure the base length distribution of RNA strands in the nucleic acid solution.

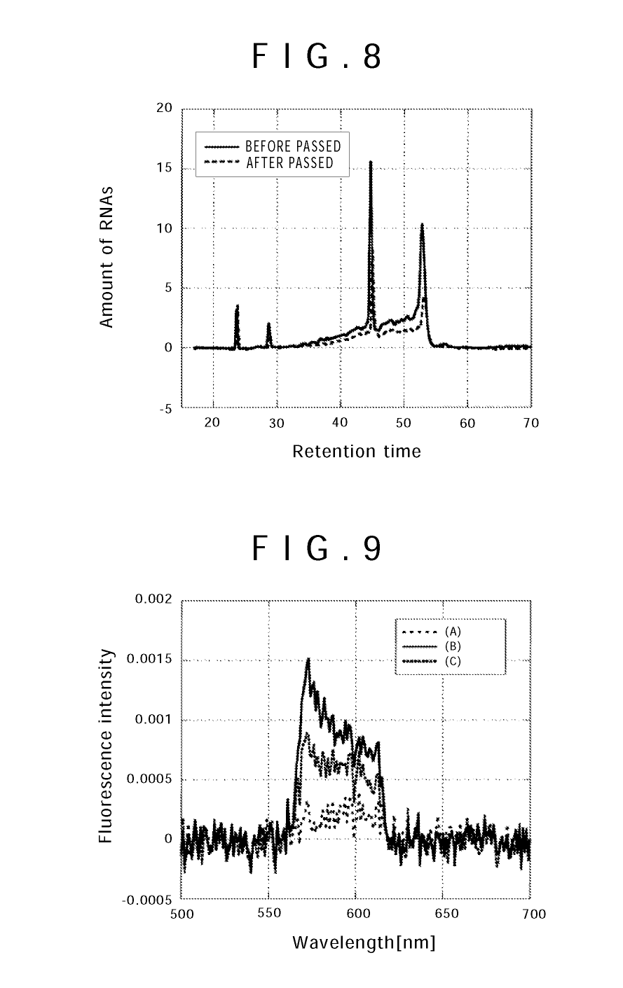

The measurement results of base length distributions are shown in FIG. 8. It is appreciated that with the nucleic acid solution after being passed through the channel, the two peaks ascribed to ribosome RNA decreased compared with the nucleic acid solution before being passed and fragmentation of the RNA occurred. These results suggest that, if a filter is arranged on an upstream side of a hybridization reaction field, nucleic acid strands would be cut into fragments upon their passage through the filter and the hybridization efficiency would be lowered.

Test 3

3. Hybridization of Nucleic Acid

(1) Syntheses of Target Nucleic Acid Strands, Capture Strands and Detection Strands

Synthesized as target nucleic acid strands was DNA the base sequence of which was randomly determined. The base sequence of the target nucleic acid strands is shown in Table 1. Also synthesized were capture strands having a base sequence complementary to the base sequence of a 5′-end portion of the target nucleic acid strands and also detection strands having a base sequence complementary to the base sequence of 3′-end portions of the target nucleic acid strands (see Table 1). Each capture strand was biotinylated at the 3′-end thereof. Further, each detection strand was labeled at the 5′-end thereof with a fluorescent dye (Cy3).

The dissociation temperatures (Tm) of the captured strands and detection strands in a 0.3 M aqueous solution of sodium chloride employed as will be described subsequently herein were both calculated to be 73° C.

TABLE 1

| | | SEQ |
|---|---|---|
| | Base sequence | ID No. |
| Target nucleic | 5′-GAAGCAGGCC CCTGCAATCC | 1 |
| acid strands | TCTCCTGGGC AGTCGTTCGG | |
| | ATATC-3′ | |
| Capture strands | 5′-AGGATTGCAG GGGCCTGCTT | 2 |
| | C-3′ | |
| Detection strands | 5′-GATATCCGAA CGACTGCCCA | 3 |
| | GG-3′ | |

(2) Preparation of Sample Solution

100 μM aqueous solutions of the target nucleic acid strands and detection strands were prepared. The target nucleic acid strand solution (20 μL) and the detection strand solution (20 μL) were mixed together. To the resulting mixture, the 0.3 M aqueous solution of sodium chloride (310 μL) which contained 0.05% agarose and 0.2% sodium dodecylsulfate (SDS) was added, followed by mixing into a sample solution.

(3) Immobilization of Capture Strands on Agarose Gel Beads

A suspension of agarose gel beads with streptavidin immobilized on the surfaces thereof (“STREPTAVIDIN AGAROSE RESIN,” trade name; product of Thermo Fisher Scientific Inc.) was provided. To the suspension of agarose gel beads (200 μL), a 100 μM aqueous solution of the capture strands (50 μL) was added, followed by suspension. Subsequently, distilled water (250 μL) was added further, and the resulting mixture was stirred.

(4) Fabrication of Nucleic Acid Hybridization Microchip

In a channel (section height: 0.5 mm, section width: 0.5 mm, channel length: 60 mm) formed in a glass-made microchip, a filter of 10 μm in pore size was arranged. The agarose gel beads were poured into the channel, and were packed there. The length of a region in the channel, the region being packed with the agarose gel beads, was set at 30 mm or so. The channel was provided with a channel switching valve and a syringe pump.

(5) Construction of Nucleic Acid Hybridization System

An in-line heater maintained at 60° C. was arranged between the channel of the microchip and the channel switching valve. The microchip was placed on a heat block maintained at 60° C.

A green LED light source was provided, and in combination with a Cy3 excitation filter, was used as an excitation light source for Cy3. A spectroscope was provided, and in combination with a Cy3 fluorescence filter, was used as a fluorescence detector for Cy3. An optical fiber cable formed of two optical fibers coaxially bundled together was provided, the optical fiber for received light was connected to the excitation light source, and the light-receiving optical fiber was connected to the fluorescence detector. An object lens which was arranged at a leading end of the optical fiber cable was placed opposite to the agarose gel beads in the channel. As a result, an optical system was constructed to irradiate excitation light onto the agarose gel beads packed in the channel and to detect the resulting fluorescence. The irradiation spot diameter of the excitation light was set at 500 μm.

(6) Measurement

The in-line heater and heat block were both set at 60° C. A hybridization solution (the 0.3 M solution of sodium chloride, which contained 0.05% agarose and 0.2% SDS) was fed into the channel to conduct conditioning of the agarose gel beads, and fluorescence measurement was performed. The feed rate was set at 50 μL/min. When the channel was observed, sticking was observed between the agarose gel beads, and the agarose gel beads were stably retained in the channel.

The sample solution (350 μL) was fed to perform sandwich hybridization between the capture strands, target nucleic acid strands and detection strands. A washing solution (the 0.3 M solution of sodium chloride, which contained 0.05% agarose and 0.2% SDS; 1.5 mL) was fed, and fluorescence measurement was performed. The feed rate was set at 50 μL/min.

The temperature settings of the in-line heater and heat block were then raised to 95° C. and 80° C., respectively. In place of the liquid phase, purified water (2.4 mL) was fed to dissociate (denature) the hybrids. Subsequent to the denaturation operation, fluorescence measurement was performed.

The fluorescence measurement results after the conditioning (A), after the feeding of the sample solution and washing solution (B), and after the denaturation operation are shown in FIG. 9. As the fluorescence intensity after the feeding of the sample solution and washing solution (B) increased compared with the fluorescence intensity after the conditioning (A), the formation of sandwich hybrids between the capture strands, target nucleic acid strands and detection strands has been confirmed. In addition, the fluorescence intensity decreased after the denaturation operation (C). Therefore, it has also been confirmed that the above-described increase in fluorescence intensity is attributed to the specific hybridization between the capture strands, target nucleic acid strands and detection strands but is not attributed to any non-specific adsorption.

In the related art, the blocking, reflection or scattering of excitation light and fluorescence occurs by the nucleic acid separation carrier. According to the microchannel and the like according to the present application, it is possible to prevent the blocking, reflection or scattering of excitation light and fluorescence, and therefore, to perform optical detection of target nucleic acid strands with high accuracy. The present application can, therefore, contribute to improvements in the accuracy of separation operation and hybridization reaction operation of nucleic acids.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A microchannel capable of passing therethrough a solution with target nucleic acid strands contained therein, comprising:
an agarose gel carrier having light transmission properties, supporting capture strands having a base sequence complementary to that of the target nucleic acid strands and immobilized on the agarose gel carrier, and packed in the microchannel; and
a filter arranged in the microchannel on a downstream side as viewed in a passing direction of the solution and retaining the agarose gel carrier.

2. A nucleic acid hybridization microchip, comprising:
a microchannel formed in the microchip;
an inlet for introducing the solution into the microchannel; and
an outlet for discharging the solution from the microchannel,
the microchannel capable of passing therethrough a solution with target nucleic acid strands contained therein including
an agarose gel carrier having light transmission properties, supporting capture strands having a base sequence complementary to that of the target nucleic acid strands and immobilized on the agarose gel carrier, and packed in the microchannel, and
a filter arranged in the microchannel on a downstream side as viewed in a passing direction of the solution and retaining the agarose gel carrier.

3. A nucleic acid hybridization system comprising:
a nucleic acid hybridization microchip; and
at least one of a heating unit for heating the solution to be introduced through the inlet and a temperature control unit for controlling a temperature in the microchannel,
the nucleic acid hybridization microchip including
a microchannel formed in the microchip,
an inlet for introducing the solution into the microchannel, and
an outlet for discharging the solution from the microchannel, and
the microchannel capable of passing therethrough a solution with target nucleic acid strands contained therein including
an agarose gel carrier having light transmission properties, supporting capture strands having a base sequence complementary to that of the target nucleic acid strands and immobilized on the agarose gel carrier, and packed in the microchannel, and
a filter arranged in the microchannel on a downstream side as viewed in a passing direction of the solution and retaining the agarose gel carrier.

4. A nucleic acid hybridization method comprising:
passing a solution, which contains target nucleic acid strands, along with an agarose-added liquid phase through a microchannel in which an agarose gel carrier, which has light transmission properties, supports capture strands having a base sequence complementary to that of the target nucleic acid strands and immobilized on the agarose gel carrier, and is packed in a state that the agarose gel carrier is retained by a filter arranged in the microchannel on a downstream side as viewed in a passing direction of the solution.

5. A nucleic acid hybridization column, comprising:
a microchannel formed in the column,
an inlet for introducing the solution into the microchannel, and
an outlet for discharging the solution from the microchannel,
the microchannel capable of passing therethrough a solution with target nucleic acid strands contained therein including
an agarose gel carrier having light transmission properties, supporting capture strands having a base sequence complementary to that of the target nucleic acid strands and immobilized on the agarose gel carrier, and packed in the microchannel, and
a filter arranged in the microchannel on a downstream side as viewed in a passing direction of the solution and retaining the agarose gel carrier.
